(19) United States
(12) Patent Application Publication
(10) Pub. No.: US 2009/0230895 A1
(43) Pub. Date: Sep. 17, 2009

(54) METHOD AND DEVICE FOR MAKING LIGHTING MODULES PART OF A DISPLAY DEVICE, WHICH LIGHTING MODULES HAVE BEEN BROUGHT RANDOMLY TOGETHER

(76) Inventors: Martin De Prycker, Sint-Niklaas (BE); Stephan Paridaen, Sint-Martens-Latem (BE); Koenraad Maenhout, Kortrijk (BE); Bruno Verhenne, Waregem (BE); Rick Buskens, Teuven (BE)

Correspondence Address: BACON & THOMAS, PLLC, 625 SLATERS LANE, FOURTH FLOOR, ALEXANDRIA, VA, 22314-1176, US

(21) Appl. No.: 12/306,194

(22) PCT Filed: Jun. 22, 2007
(86) PCT No.: PCT/EP07/05602

§ 371 Date: Dec. 22, 2008

(30) Foreign Application Priority Data
Jun. 22, 2006 (EP) 06012790.9

(51) Int. Cl. H05B 37/00

(52) U.S. Cl. 315/317

(57) ABSTRACT

The present invention relates to a method and device for communicating data to devices which have been brought randomly together, e.g. user equipment provided to a plurality of persons grouped within a geographical area, e.g. an audience or spectators, for example as used in concerts or sports events, in particular for example such that the user equipment effectively forms part of a light emitting display device.

### TECHNICAL FIELD OF THE INVENTION

The present invention relates to a method for communicating pixelated data of an image to a plurality of devices which are randomly brought together, e.g. persons provided with user equipment and grouped within a geographical area, such as for example an audience or spectators, for example as used in concerts or sports events. In particular, embodiments of the present invention concern a system and method such that such randomly brought together devices, e.g. user equipment, effectively form part of a light emitting display device for displaying an image.

### BACKGROUND OF THE INVENTION

During concerts audience members are often given small white or coloured light sources that can be used during the show. Such light sources are independent and do not have any ability to interact; they are simply used by each audience member as desired.

WO 93/12614 describes an audience response system in which each audience member is provided with a reflective device which is, for example, green on one side and red on the other side. Light from a spotlight is reflected from the reflective devices and imaged by a conventional video camera. A computer receives the digitised and processed image, forms a map of the audience, and distinguishes the red from the green reflections. This data is then used by the computer to project an image onto a screen visible to the audience, the image being controlled by the red or green image reflections. The audience thus jointly controls the screen image, for instance for purposes of voting or playing a game. The system can also detect movement (direction and/or velocities) of each radiation source which data is aggregated and thereby manipulates the screen image. Also, the sources each may transmit coded information, such as Morse code or ASCII, to individually identify themselves.

### SUMMARY OF THE INVENTION

It is an object of the present invention to provide a system and method wherein devices which are randomly brought together, such as e.g. user equipment, effectively form part of a light emitting display device.

The above objective is accomplished by a method and device according to the present invention.

In a first aspect, the present invention provides a method for communicating data suitable for use with a plurality of lighting modules randomly brought together and grouped within a geographical area, each lighting module being at a location within the geographical area. The method comprises determining the position of the individual lighting modules within the geographical area, and thereafter communicating data to each of the lighting modules. The data communicated relates to an image to be displayed by a combination of the lighting modules. The data is thus pixelated data in an image, The image is provided from an image source such as an image generator and parts of the image are distributed among the individual lighting modules, e.g. via wireless communication. This way, the individual lighting modules form part of the display device.

The method according to embodiments of the present invention may be for use with a plurality of persons grouped within a geographical area. In this embodiment, the method may comprise providing a plurality of persons with audience user equipment under the form of or comprising an individual lighting module. This way, the audience user equipment forms part of the display device.

Advantageously, the lighting modules may be LED modules, which is power efficient, as LED modules consume only little power. Therefore, the lighting modules can easily be battery-operated.

The lighting modules may be multi-colour lighting modules, e.g. RGB modules. In this case, multi-colour images can be shown. Alternatively, the lighting modules may be monochrome modules, in which case “black and white” (depending on the colour of light emitted by the modules) or binary images may be shown. The images shown may be patterns, for example moving patterns, e.g. a white line from the centre of the hall towards the outer border of the hall is displayed and is rotating over 360° around the hall. On top of the display of the line, acts or movements of the persons may be requested, e.g. in case of the rotating line, the persons that see their lighting module turn on have to raise their hands, which will produce a Mexican wave effect.

Determining the position of the individual lighting modules may be performed by the lighting modules themselves, e.g. by using GPS positioning information. Alternatively, determining the position of the individual lighting modules may comprise detecting and localising the lighting modules. This detecting and localising may comprise communicating between neighboring lighting modules so as to obtain identification data of neighboring lighting modules. Alternatively, this detecting and localising may comprise using a camera or scanning light sensor for observing the plurality of persons. According to still an alternative embodiment, this detecting and localising the lighting modules may comprise using a transmitter sending a signal upon reception of which the lighting modules respond by sending their unique identification data. According to yet another alternative embodiment, the detecting and localising may comprise using a global positioning system.

Communicating data to each of the lighting modules may comprise sending complete image information to each lighting module which extracts information corresponding to its determined position. This way of working makes data transfer easier, as the data transferred is the same for each lighting module. Communicating data to each of the lighting modules may comprise sending complete information to each lighting module with geographical co-ordinates encoded therein. Geographical co-ordinates encoded in the information allow a device to extract the right information, i.e. the information the lighting module needs to display, from the complete image information. An advantage of transmitting with the data the geographical co-ordinates to which the data applies is that the lighting module itself decides whether or not it is in the relevant area, and if so, displays the information.

Alternatively, communicating data to each of the lighting modules may comprise sending, to each lighting module, image information corresponding to its determined position. This way, location dependent data can be sent to e.g. people or devices moving inside their group, e.g. moving audience or spectator members, or moving marbles, confetti, etc. This has the advantage that only limited data transfer to each lighting module takes place.

A method according to embodiments of the present invention may furthermore comprise synchronising data communicated to each of the lighting modules. This way, all lighting modules show part of the same image at the same time and less distortions occur during display of the image(s).

In a second aspect, the present invention provides a display system for displaying an image. The display system comprises a transmission unit, a plurality of individual lighting modules, and means for determining the position of the individual lighting modules. Each lighting module comprises at least one light source having at least two states, a communication means for receiving data, and a processing means for bringing the at least one light source into one of its states depending on received data. The lighting modules are adapted for receiving data from the transmission unit, the received data relating to an image to be displayed by a combination of the lighting modules, and for displaying at least part of this received data as at least a pixel of the image to be displayed depending on the determined position of the lighting modules. Received data relating to an image to be displayed includes both image data itself or, when image data has been preloaded into each of the lighting devices, identification and synchronisation information relating to the images to be displayed.

The lighting modules may be adapted for being provided to a plurality of persons. They may for example be hand-held devices, and therefore have suitable dimensions for being hand-held, optionally having a handle, or they may be provided with means for attaching them to clothing or other devices such as bags, hats, umbrellas, worn by people.

The means for determining the position of the individual lighting modules may be external to the lighting modules. Alternatively, the means for determining the position of the individual lighting modules may be internal to the lighting modules.

The lighting modules may be LED modules.

The lighting modules may be multi-colour lighting modules, such as e.g. RGB modules.

The lighting modules may be movable. They may be portable by a person.

The display system according to the present invention furthermore may comprise synchronisation means for synchronising display of the data received by the individual lighting modules.

In an aspect, the present invention forms lighting modules by adding intelligence and data communication capabilities, with the ability to emit light, possibly e.g. multi-colour light such as red, green and blue light from these light sources. Such lighting modules communicate with a transmission unit so as to receive data such that the user equipment effectively forms part of a (colour) light emitting display device.

Particular and preferred aspects of the invention are set out in the accompanying independent and dependent claims. Features from the dependent claims may be combined with features of the independent claims and with features of other dependent claims as appropriate and not merely as explicitly set out in the claims.

For the avoidance of doubt the present invention may be implemented in a dedicated device in stand-alone form (either hand-held or free-standing) or comprised within a larger device or host device/system comprising other functionality, for example a mobile communications device, PDA, personal computer, laptop, game console.

It will be understood by persons skilled in the art that many other systems, devices and methods can be advantageously designed incorporating the present invention.

The above and other characteristics, features and advantages of the present invention will become apparent from the following detailed description, taken in conjunction with the accompanying drawings, which illustrate, by way of example only, the principles of the invention. This description is given for the sake of example only, without limiting the scope of the invention. The reference figures quoted below refer to the attached drawings.

### BRIEF DESCRIPTION OF THE DRAWINGS

FIG. 1 is a flow diagram of a method according to embodiments of the present invention.

FIG. 2 is a block diagram of a particular embodiment of a lighting module.

FIG. 3 shows a user, e.g. an audience member, holding a lighting module as illustrated in FIG. 2.

FIG. 4 shows a plan view of an example arena filled with people, e.g. audience members, each equipped with a lighting module, the lighting modules being driven so as to show an image.

FIG. 5 shows a similar example area plan view with example location beacon transmitters.

FIG. 6 illustrates a display system according to embodiments of the present invention, comprising a transmission unit and a plurality of lighting modules.

In the different figures, the same reference signs refer to the same or analogous elements.

### DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

The invention will now be described by a detailed description of several embodiments of the invention. It is clear that other embodiments of the invention can be configured according to the knowledge of persons skilled in the art without departing from the true spirit or technical teaching of the invention, the invention being limited only by the terms of the appended claims.

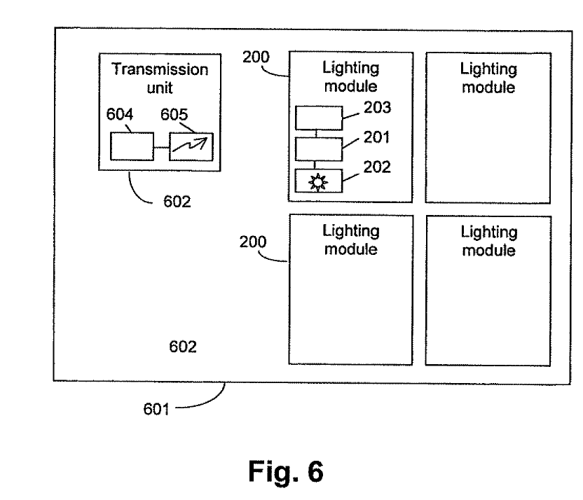

A wireless display system 601 according to embodiments of the present invention is illustrated in FIG. 6 and comprises a transmission unit 602 and a plurality of receiving units 200. The transmission unit 602 comprises a central controller 604 and a first data communication means 605 for communicating data relating to an image to be displayed by a combination of receiving units 200.

In some embodiments of the present invention, an image is provided by a centralised image source such as a digital representation of an image, e.g. stored in memory or on a storage device such as an optical disk, solid state memory, tape or magnetic disk or the image is generated by an image generator. This image is to be distributed among the receiving units 200. Data relating to an image to be displayed may, in these embodiments, be the image itself. Each of the receiving units 200, further called lighting modules, comprises at least one light source or light emitter 202 having at least two states, a data receiver or communicator 203 for at least receiving data communicated by the transmission unit 602, and a module controller 201 for bringing the at least one light emitter 202 into one of its states depending on received data.

In alternative embodiments, each receiving unit 200 may be preloaded with one or more video streams. The receiving units 200 are then provided with memory means for storing the preloaded one or more video streams. In that case, data relating to an image to be displayed which is communicated to each of the receiving units 200 may be only identification and/or synchronisation information for enabling each receiving unit 200 to make a selection of the right frame of the right video stream to be displayed. Each receiving unit 200 in this embodiment contains the complete image, but depending on its position, only a portion (one or more pixels) thereof is taken out of the stream and is displayed by that receiving unit 200.

Such display system 601 as illustrated in FIG. 6 may be implemented in a performance event, such as a musical concert or a sports event for example, where a plurality or all of the members of an audience or spectators, or all or a plurality of audience or spectator locations such as seats are equipped with a lighting module 200. Data transmitted from the transmission unit 602 towards each of the lighting modules 200 may be used by the audience or spectators, for example to generate an image.

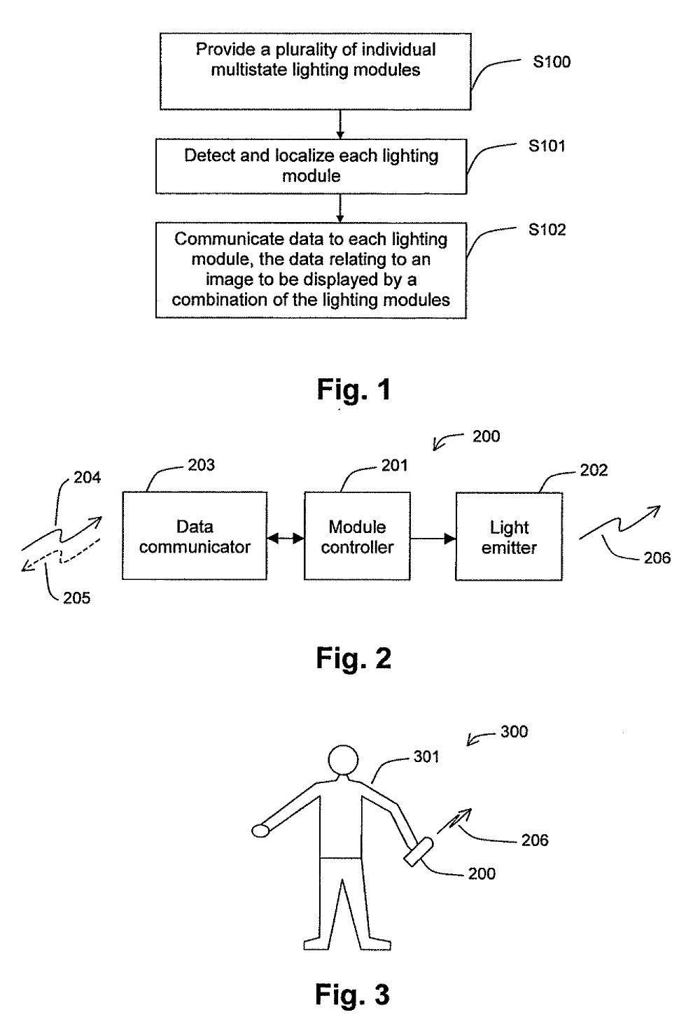

FIG. 1 is a flow diagram of embodiments of the method of the present invention. The method comprises step S100, step S101 and step S102 and is for communicating data to a plurality of lighting modules 200 grouped within a geographical area, the data communicated relating to an image to be displayed by a combination of the lighting modules. The data relating to an image to be displayed may be image data itself, or, in case the lighting modules 200 are preloaded with image data, only identification and/or synchronisation data. In this latter case, from the identification and/or synchronisation data, each lighting module 200 can work out what image, e.g. video stream, to display at what moment in time. The data visualised by each of the lighting modules 200 is one or at most a few pixels of the complete image to be displayed by the display system 601.

At step S100, a plurality of individual lighting modules 200 are provided, e.g. during a performance event each audience or spectator member is equipped with one or more individual lighting modules 200. According to an embodiment, each lighting module 200 has been pre-programmed with a unique address and/or unique identification tag, e.g. identification number, and therefore the transmission unit 602 may communicate with each lighting module 200 individually. Preferred embodiments of the lighting module 200 are described in more detail later in the description with respect to FIG. 2.

Referring again to FIG. 1, according to an embodiment of the present invention, at step S101 the central controller 604 within the transmission unit 602 operates to detect and localise each lighting module 200, i.e. determine the position thereof. The display system 601 comprises one or more first data communication units 605 in communication with each other located at one or more positions in and/or above and/or around the audience or spectator arena. At the end of step S101, the central controller 604 of the transmission unit 602 knows the location of each lighting module 200 and each lighting module 200 knows its own location. Examples of this detection and localisation process will be described in more detail below.

At step S102 the transmission unit 602, by means of its first data communication means 605, communicates data to each lighting module 200 where such data is relevant to each lighting module 200 at that time and for the current application. The communicated data may be actual image data to be displayed, or, when image data has been preloaded into each of the lighting modules 200, only identification and/or synchronisation information.

According to embodiments of the present invention, the communicated data relates to video picture information such that each lighting module 200 outputs light of an intensity and possibly colour relating to a pixel (or at most a few pixels) within the video picture. Persons skilled in the art will know that a pixel is the term often used to represent a picture element when pictures are broken down into an array of elements for display purposes. In this way the user equipment, i.e. lighting modules 200, of the members of the audience or the spectators effectively form part of a light emitting display device. A pixel may include light emitting subpixels.

According to another embodiment of the present invention, the netcentric detecting of the location of the lighting modules may be omitted. In this case, co-ordinates are transmitted to the lighting modules, which co-ordinates are determined by the geographical area of interest, e.g. the borders of that geographical area where the image is to be displayed, for example a sports arena. The lighting modules decide, for example based on GPS positioning information, whether or not they are present in the geographical area of interest. Image information containing geographical co-ordinates encoded therein is broadcast to each of the lighting modules. The lighting modules, knowing their position and receiving the image information, extract from the received image information the portion of interest, i.e. work out from the received complete image information which part they are supposed to display. Alternatively, when the image information is stored locally into each of the lighting modules, each lighting module determines, based on the received co-ordinates and on received identification and/or synchronisation information, whether they need to display part of the image or not, as well as which part they need to display. Each lighting module in this embodiment contains the complete image, but depending on its position, only a portion (one or more pixels) thereof is taken out of the stream and is displayed by the lighting module.

In some embodiments data is additionally communicated from each lighting module 200 to the transmission unit 602, for example its geographical localisation.

Steps S101 and S102 are continuously repeated during system operation so that for example as audience or spectator members move around an arena their new locations are determined so as to receive correct position-related information.

Example means of accomplishing steps S101, S102 and S103 will now be described in more detail.

FIG. 2 is a block diagram of an example lighting module 200 according to an embodiment of the present invention, which lighting module 200 may be used e.g. to equip each spectator or each member of an audience. Lighting module 200 comprises module controller 201, light emitter 202, and data communicator 203. The module controller 201 receives data from and may optionally send data to the data communicator 203. The module controller 201 sends control and power signals to the light emitter 202. The light emitter 202 comprises one or more visible-light emitters and has at least two states, i.e. e.g. at least an ON and an OFF state. The one or more visible-light emitters may be capable of emitting white light, or alternatively may be able to emit multi-coloured light such as red (R), green (G) and blue light (B) 206; persons skilled in the art will know that combinations of R, G and B can be used to produce any desired pixel colour. The light emitter 202 may preferably comprise one or more LEDs (light emitting diodes), however persons skilled in the art will know that any other known visible-light emitters may be used, such as for example: electroluminescent, backlit-liquid-crystal, incandescent, discharge lamps or plasma. The light emitter 202 may provide pixel information such that observers of the audience or spectators see video pictures produced across the audience or spectators as described above. The present invention is, however, not limited to video, but also includes images, text, or information. The lighting module 200 may send data (position and/or identification data for example) to the transmission unit 602. The light emitter 202 may provide position-related information to the audience member or spectator equipped with the lighting module 200. The data communicator 203 comprises wireless communication means such as for example a light detector (for visible, infra-red, or ultra-violet for example), radio-frequency antenna, and/or inductive-coupling antenna. The data communicator 203 will receive data 204 from the transmission unit 602 and may receive data from nearby lighting modules 200. The data communicator 203 may send data 205 to the first data communication means 606 of the transmission unit 602 and/or may send data to nearby lighting modules 200. The data communicator may be adapted to receive geographical position data, e.g. by means of a GPS receiver.

The lighting modules 200 may use a same interface for defining their position as the interface they use of transferring/receiving image data. Examples of communication techniques which may be used in these embodiments are license-free communication bands such as UWB (Ultra Wide Band) or ISM (industrial, Scientific, Medical) bands, covering communication protocols such as e.g. Bluetooth, WiFi, Zigbee. Alternatively, a licensed frequency band may be used for this type of communication, e.g. GSM, UHF, VHF.

In alternative embodiments, different interfaces may be used for defining position and for transferring images. As examples only, the present invention not being limited thereto, for defining position of the lighting modules 200, any of the following communication technologies may be used: license-free communication bands such as UWB or ISM bands, covering communication protocols such as e.g. Bluetooth, WiFi, Zigbee; using a licensed frequency band, e.g. GSM, UHF, VHF; optical communication, including laserlight, visual, infrared or UV; ultrasound measurement; GPS; radar; determining the position of RFIDs in the lighting modules 200. Transferring images may for example be performed by any of the following, the present invention not being limited thereto, proprietary terrestrial communication bands, e.g. FM, UHF, VHF; DVB (digital), -T (terrestrial), -M (mobile) or -S (satellite); ISM, e.g. WiFi, Zigbee, Bluetooth; images may be preloaded and only limited identification and/or synchronisation information may be transmitted, requiring only limited bandwidth; remotely triggered only over any wireless interface.

Independent of the communication techniques used, position determination may for example be performed by any of the following techniques: time based (time*travelling speed=distance), signal/field strength based, phase comparison e.g. carrier phase comparison, angle or direction based e.g. angle of arrival based, inertia sensor (motion sensor), accelerometer, gyroscope, interference patterns, position distinguishing transmission, proximity detection, any combination or derivative of the above. The above are intended to be examples only, and it is not intended to limit the present invention thereto.

In accordance with embodiments of the present invention, the detection and localisation resolution (position accuracy) may be high enough to distinguish every singe device. Devices carried by people require an accuracy between 10 and 100 cm. Smaller devices that can be arranged close to each other, such as e.g. marbles or confetti, might require a much higher position accuracy, as high as a centimetre or in the millimetre range. The required refresh time of the position measurement is dependent on the speed at which the devices can move. Devices carried by moving people might require a position refresh rate of a few times per second, e.g. 1 to 10 times per second. Other free devices which are moving faster may require a higher position refresh rate, e.g. 20 to 50 times per second. (Semi-) static applications might be satisfied with a once-only initialisation or very low position refresh rate, e.g. a few times per minute. Dependent on the application, position determination may be 2-dimensional or 3-dimensional. Theoretically there is no limit to the number of devices. Practical limits can be the maximum number of people that can be brought together, but for free devices the image data providing seems to be the first limit, although, dependent on the method, several millions of pixels must be feasible.

In a particular embodiment, the lighting modules 200 are video oriented, i.e. adapted for displaying video information. This implies that the lighting modules 200 may have a wide viewing angle (typically 120°) and a wide colour triangle. The plurality of lighting modules may be calibrated so that they all generate a same colour when driven the same way. This calibration may be obtained by gathering the light output information, in particular colour information, and defining the smallest colour triangle common to all lighting modules. This information is then provided to the processing means of each lighting module, for use during processing of data received by the lighting modules.

FIG. 3 is a diagrammatic representation 300 of an audience member or spectator 301 equipped with a lighting module 200. The audience member or spectator 301 is shown holding a lighting module 200 and emitted light 206 is shown. However, the lighting module 200 may alternatively be carried in other ways for example as a badge, bracelet, necklace, pendant, incorporated in or attached to textile e.g. clothes, a hat, a vest, a shirt, to bags e.g. a backpack, to a cap, or as an integral part of an item of apparel, such as e.g. a torch, a cigarette lighter, a cell phone, a stick, a flag, an umbrella, a balloon. A plurality of individual lighting modules 200 may be carried by a single audience member or spectator 301. A further alternative method of equipping an audience member or spectator 301 with a lighting module where audiences or spectators are seated is such that a lighting module is built-in or attached to the seat.

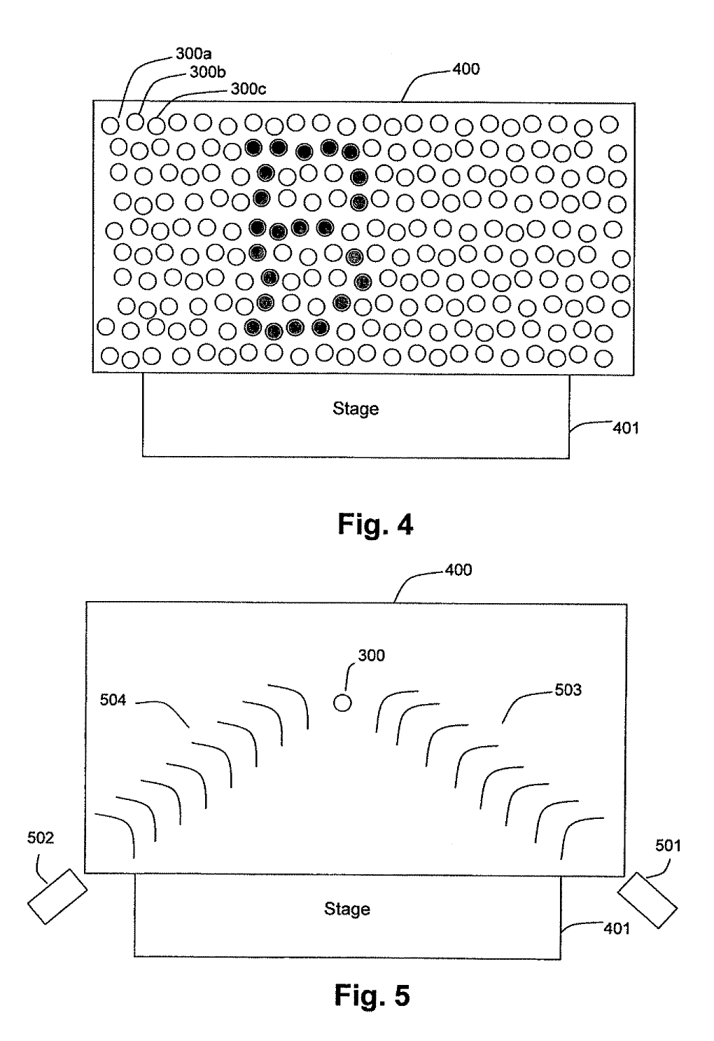

FIG. 4 is a plan view of an example audience in an arena 400 next to a performance stage 401. In this example the audience comprises approximately 120 people 300 equipped with a lighting module (for clarity only three are labelled: 300a, 300b and 300c). Persons skilled in the art will know that an arena 400, i.e. geographical area of interest for the present invention, and/or stage 401 may be of any size or shape and may be enclosed and/or in the open-air. In this example each circle representing an audience member 300 equipped with a lighting module 200 also represents the light 206 emitted from the lighting module 200 and in the example shown the display screen comprising the user equipment carried by the audience members 300 is showing a capital letter B. Persons skilled in the art will know that any picture, text and/or graphic images still and/or moving video may be displayed on the display screen comprising the user equipment carried by the audience members.

Example methods to accomplish step S101 (FIG. 1) will now be described.

A first particular method to accomplish step S101 (FIG. 1) uses a handshake principle where each lighting module 200 (FIG. 2) communicates with nearby neighbouring lighting modules 200 such that all lighting modules 200 know the identification data, e.g. identification numbers, of nearby lighting modules 200. Such information is communicated to the transmission unit 602 such that the central controller 604 can operate suitable algorithms to build-up a map of the sequence of lighting module locations and therefore will know the position of each lighting module 200. The position information relating to each lighting module 200 is then communicated to that lighting module 200 via each lighting module's data communicator 203.

A second particular method to accomplish step S101 (FIG. 1) uses a camera or scanning light sensor positioned above the audience or spectators and is therefore able to observe the audience or spectators, and an example of such an observed audience or spectators is shown in FIG. 4. The camera or scanning light sensor communicates with the transmission unit 602 and the transmission unit 602 communicates with all lighting modules 200 to request that they send their unique identification data, e.g. identification numbers, using coded modulation of their light emitters 202. The transmission unit 602 running a suitable algorithm extracts the identification information and position information relating to each identified lighting module 200 from data communicated from the camera or scanning light sensor and therefore will know the position of each lighting module 200. The position information relating to each lighting module 200 is then communicated to that lighting module 200 via each lighting module's data communicator 203.

A third particular method to accomplish step S101 (FIG. 1) uses a camera positioned above the audience or spectators as described for the second preferred method above. The camera communicates with the transmission unit 602 and the transmission unit 602 communicates with all lighting modules 200 individually using their unique identification data, e.g. identification numbers, one at a time to request that they momentary light up their light emitters 202. The transmission unit 602 running a suitable algorithm extracts the position information from the camera relating to each known lighting module 200 and therefore will know the position of each lighting module 200. The position information relating to each lighting module 200 is then communicated to that lighting module 200 via each lighting module's data communicator 203.

A fourth particular method to accomplish step S101 (FIG. 1) uses two or more transmitters, which are usually located at corners of an arena. FIG. 5 shows an example plan view of an arena 400 and stage 401 showing examples of two such transmitters 501 and 502. Each transmitter 501, 502 sends a signal in only one direction shown as 503 and 504 respectively. The signals may be orthogonal. In FIG. 5 only one audience or spectator member 300 equipped with a lighting module 200 is shown for clarity purposes. The transmitters 501, 502 may scan the arena 400 such that as each lighting module 200 receives such scanning signals 503, 504, it responds by sending its unique identification data, e.g. identification number. The transmitters 501, 502 communicate with the transmission unit 602. The transmission unit 602 running a suitable algorithm extracts the identification information and position information relating to each identified lighting module 200 from data communicated from the transmitters 501, 502 and therefore will know the position of each lighting module 200. The position information relating to each lighting module 200 is then communicated to that lighting module 200 via each lighting module's data communicator 203.

A fifth particular method to accomplish step S101 (FIG. 1) uses a local version of known global positioning systems. Two or more local transmitters send position and time information on a continuous basis and examples of such transmitter locations are shown as 501 and 502 on FIG. 5, however in this case each of their signals are broadcast over the whole of the arena 400. The module controller 201 within each lighting module 200 operates a suitable algorithm (of type known to persons skilled in the art) to determine its own position derived from the signals received via data communicator 203 from transmitters 501 and 502 (FIG. 5).

Persons skilled in the art will know that the methods described above to accomplish step S101 (FIG. 1) are examples only and that other known communication and location methods may be used and/or combinations of the example methods may be used. The accuracy of the detection system determines the quality of the image shown. With a high accuracy, the lighting modules of the people grouped within the geographical area can form part of a high resolution display system, possibly resulting in a high resolution image being shown. With a lower position detection accuracy, the squares that define a pixel must be much bigger, hence resulting in a lower resolution image being shown.

Example methods to accomplish step S102 (FIG. 1) where such communicated data is used to display images will now be described. Depending on the available transmission technology and/or the storage capacity of the lighting modules 200 for storing images, high resolution or low resolution images, or other information related to the images, such as identification and/or synchronisation information, can be broadcast. The decision to broadcast high resolution or low resolution images can furthermore also be based on any of the available processing power in the lighting modules 200, and/or the accuracy of the position determination. For a same crowd being present, broadcasting a higher resolution image can result in the same image quality when processing power of the lighting module or the accuracy of the location determination is not powerful enough to take advantage of the extra information present in the high resolution image. Alternatively, a higher resolution result of the image may be achieved if both processing power of the lighting module and accuracy of the location determination is sufficiently high.

A first particular method to accomplish step S102 (FIG. 1) where the communicated data is used to display images is such that the transmission unit 602 sends complete image information to each lighting module 200. Each lighting module 200 knows its position and so when the pixel information relating to that position is received by its data communicator 203 and communicated to its module controller 201, the module controller 201 works out which pixel information is to be displayed by the lighting module 200 and causes that pixel information to be displayed by the light emitter 202.

A second particular method to accomplish step S102 (FIG. 1) where such communicated data is used to display images is such that each lighting module 200 communicates with the transmission unit 602 to request pixel data relating to the lighting module's known position. Then, when the pixel information relating to that position is received by the lighting module's data communicator 203 and communicated to its module controller 201, the module controller 201 causes the pixel information to be displayed by the light emitter 202.

A third particular method to accomplish step S102 (FIG. 1) where such communicated data is used to display images is such that the transmission unit 602 knows the position of each lighting module 200 and sends pixel information relating to each lighting module 200 to each lighting module 200 in turn. Each lighting module 200 receives its pixel data at the communicator 203 and communicates the data to its module controller 201. The module controller 201 causes the pixel information to be displayed by the light emitter 202.

A fourth particular method to accomplish step S102 (FIG. 1), where the lighting modules 200 each are preloaded with and store one or more images or video streams, is, rather than to broadcast the complete video content to each of the lighting modules 200, to broadcast only identification and/or synchronisation information. Each lighting module 200 knows its position and so when the identification and/or synchronisation information is received by its data communicator 203 and communicated to its module controller 201, the module controller 201 works out which part of the preloaded image or video stream is to be displayed by the lighting module 200 and causes the corresponding pixel information to be displayed by the light emitter 202.

It is clear that the distribution of data towards the lighting modules 200 and the refresh of such data, in some embodiments of the present invention, should preferably be synchronised in order to allow the lighting modules 200 to receive and process the data received, all lighting modules 200 at the same time. Therefore, the display system may be arranged with synchronisation means to form a substantially real-time system to display video.

In some applications it may be advantageous to sub-divide arena areas with additional system apparatus such that fewer numbers of pixels are controlled by each corresponding transmission unit sub-set.

It is to be understood that although preferred embodiments, specific constructions and configurations, as well as materials, have been discussed herein for devices according to the present invention, various changes or modifications in form and detail may be made without departing from the scope and spirit of this invention, For example, embodiments of the present invention have been described by referring to members of an audience carrying equipment. Such devices provided with a lighting module according to embodiments of the present invention may be carried by different types of people, e.g. actors, personnel, visitors, guests, spectators, audience members.

In alternative embodiments, the features of the present invention may also be applied to other lighting modules randomly brought together. As examples only, the lighting modules in accordance with embodiments of the present invention may be incorporated in floating or sinking devices intended for being thrown in a pool, as an alternative to throwing coins in a pool, as is traditionally done for example in the Trevi Fountain in Rome. When people throw a lighting module in accordance with embodiments of the present invention into the pool, its location is determined and data relating to an image to be displayed is communicated to it, after which the lighting module displays its part of a bigger image, this part depending on the exact position of the lighting module. In still alternative embodiments, the lighting modules in accordance with embodiments of the present invention may be incorporated into or attached to non-userheld moving devices, such as e.g. marbles, balls, video tiles, facade elements, decorative sticks, lighting devices, festoons, confetti, balloons, cars, self-driving vehicles, robots, objects on an assembly line or conveyor belt, toys, wind operated devices, a flock of birds, a school of fish. These non-userheld devices may be free, e.g. falling, rolling, thrown, suspended, floating, levitated, gliding, bouncing; may be moving, rotating, tilting, lifting, expanding, etc. The non-userheld devices may be fixed on moving objects or installations e.g. on an arm, a robot, a vehicle, a moving wall etc. It has a large added value when the devices together are able to correctly display graphic information at all time, independent of the movements of the objects or the parts of the installation. In accordance with embodiments of the present invention, the position of any of the above non-userheld devices within a predetermined geographical area may be determined, and depending on their location, they may show a different part of an image, as set out above for the user-held devices. In accordance with embodiments of the present invention, random occurrence of any of such devices may form arranged images.

In still alternative embodiments, lighting modules in accordance with embodiments of the present invention may be fixed, e.g. on a stage, rig, building, work of art.

Applications of embodiments of the present invention may be to create a trend, a fashion, a hype; it may be used for promotion of goods, advertisement; and it may have applications in theatre, show and entertainment.

1-24. (canceled)

25. Method for communicating data for use with a plurality of lighting modules (200), grouped within a geographical area, each lighting module (200) being at a location within the geographical area, the method comprising:
communicating (S102) data (204) to each of the lighting modules (200), wherein the data (204) communicated relates to an image to be displayed by a combination of the lighting modules (200);
bringing the lighting modules randomly together; and
determining the position of the individual lighting modules (200) within the geographical area before communicating (S102) data (204) to each of the lighting modules (200).

26. Method according to claim 25 using a plurality of persons (300) grouped within a geographical area, each person having an individual lighting module (200).

27. Method according to claim 25, wherein the lighting module (200) is a LED module.

28. Method according to claim 25, wherein the lighting module (200) is a multi-colour lighting module.

29. Method according to claim 28, wherein the lighting module (200) is an RGB module.

30. Method according to claim 25, wherein determining the position of the individual lighting modules (200) is performed by the lighting modules themselves.

31. Method according to claim 25, wherein determining the position of the individual lighting modules (200) comprises detecting and localizing (S101) the lighting modules (200).

32. Method according to claim 31, wherein detecting and localizing (S101) the lighting modules (200) comprises communicating between neighboring lighting modules (200) so as to obtain identification data of neighboring lighting modules (200).

33. Method according to claim 31, using a plurality of persons (300) grouped within a geographical area, each person having an individual lighting module (200); wherein detecting and localizing (S101) the lighting modules (200) comprises using a camera or scanning light sensor for observing the plurality of persons.

34. Method according to claim 31, wherein detecting and localizing (S101) the lighting modules (200) comprises using a transmitter sending a signal upon reception of which the lighting modules (200) respond by sending their unique identification data.

35. Method according to claim 31, wherein detecting and localizing (S101) the lighting modules (200) comprises using a global positioning system.

36. Method according to claim 25, wherein communicating data (S102) to each of the lighting modules (200) comprises sending complete image information to each lighting module (200) which extracts information corresponding to its determined position.

37. Method according to claim 36, wherein communicating data (S102) to each of the lighting modules (200) comprises sending complete information to each lighting module (200) with geographical co-ordinates encoded therein.

38. Method according to claim 25, wherein communicating data (S102) to each of the lighting modules (200) comprises sending to each lighting module (200) image information corresponding to its determined position.

39. Method according to claim 25, furthermore comprising synchronizing data communicated to each of the lighting modules (200).

40. Display system (601) for displaying an image, the display system (601) comprising:
a transmission unit (602);
a plurality of individual lighting modules (200) each comprising at least one light source (202) having at least two states, a communication unit (203) for receiving data, and a processing unit (201) for bringing the at least one light source (202) into one of its states depending on received data; and
a unit for determining the position of the individual lighting modules (200);
the lighting modules (200) being adapted to receive data from the transmission unit (602), the received data relating to an image to be displayed by a combination of the lighting modules (200), and to display at least part of the image based on this received data as at least a pixel of the image to be displayed depending on the determined position of the lighting modules (200).

41. Display system (601) according to claim 40, wherein the lighting modules (200) are adapted to be accommodated by a plurality of persons.

42. Display system (601) according to claim 40, wherein the unit for determining the position of the individual lighting modules is external to the lighting modules (200).

43. Display system (601) according to claim 40, wherein the unit for determining the position of the individual lighting modules is internal to the lighting modules (200).

44. Display system (601) according to claim 40, wherein the lighting module (200) is a LED module.

45. Display system (601) according to claims 40, wherein the lighting module (200) is a multi-color lighting module.

46. Display system (601) according to claim 45, wherein the lighting module is an RGB module.

47. Display system according to claim 40, wherein the lighting modules are movable.

48. Display system according to claim 40, furthermore comprising a synchronizer that synchronizes display of the data received by the lighting modules (200).
